(19) United States
(12) Patent Application Publication
(10) Pub. No.: US 2014/0288983 A1
(43) Pub. Date: Sep. 25, 2014

(54) SYSTEMS AND METHODS FOR USING A DESIGNER/DEVELOPER DISCIPLINE MAP

(71) Applicants: R. Douglas Winnie, San Francisco, CA (US); Sharma K. Hendel, Oakland, CA (US); Darcey A. Merriam, Alameda, CA (US); Wilson L. Chan, San Jose, CA (US)

(72) Inventors: R. Douglas Winnie, San Francisco, CA (US); Sharma K. Hendel, Oakland, CA (US); Darcey A. Merriam, Alameda, CA (US); Wilson L. Chan, San Jose, CA (US)

(21) Appl. No.: 12/617,227

(22) Filed: Nov. 12, 2009

(51) Int. Cl. G06Q 10/00; G06N 5/02

(52) U.S. Cl. 705/7.14; 706/54; 705/7.39

(57) ABSTRACT

Systems and methods are disclosed for creating a discipline map for a user and using the discipline map to assess the knowledge and experience of the user in a designer/developer context for a project. The discipline map may represent one or more attributes and an ability level the user possesses for one or more attributes. An attribute can be a set of skills associated with designer tasks and/or developer tasks of a project. A skill can be obtained through training and experience and a skill can predict whether the user can successfully complete the task. The ability levels may represent depth of a user's knowledge and experience. Discipline maps according to certain embodiments can be used to assess educational needs of one or more users, to allow a user to conduct a personal assessment of his or her strengths and weaknesses, and to plan a project such as a software project.

### FIELD

This disclosure relates generally to computer software that runs, displays, provides, or otherwise uses electronic content.

### BACKGROUND

The knowledge and experience of a user are useful types of information for project planning, educational needs assessment, and personal assessment, among other purposes, involving that user. For example, the knowledge and experience of a user can be used by a project manager to assign project tasks to that user such that the project is completed in an efficient and useful manner.

In some projects, tasks can include designer tasks and/or developer tasks. Designer tasks can relate to presentation and user interface components of a project. Developer tasks can relate to the creation and implementation of software code and data relationships to support the presentation and user interface components. A project manager can assign a designer task to a user having knowledge and experience related to project design and can assign a developer task to a user having knowledge and experience related to project development.

Determining the user to which to assign a designer task or a developer task can be based on current job title, previous job title(s), and education level attainment. This information, however, may be general or otherwise incomparable to information about other users. A project manager may be unable to compare knowledge and experience of available designers and developers. For example, job titles—current or previous—may be a general title such as “art director” or “assistant developer” that may have meaning in the organization with which the user is associated, but can have many different meanings outside of the organization. For example, users with the same title, such as “graphic designer” or “web developer,” may have drastically different skills and different levels of skills such that the users may or may not be appropriate to perform certain tasks of a project. Education level attainment may be a general level that does not relate specifically to a user's knowledge and experience with particular project designer and developer tools, technologies, paradigms, concepts, and contexts, for example. Thus, analyzing the knowledge and experience of available designers and developers by the project manager can be difficult. Although a larger data collection represented by a list or spreadsheet can assist a project manager in assigning tasks or otherwise managing a project, the list or spreadsheet may be relatively large and it may be time consuming for the project manager to analyze the list or spreadsheet for project management purposes.

Similarly, it can be difficult to use such information, including information represented by lists or spreadsheets, to assess a user's educational needs or for a user to use such information to conduct a personal assessment to determine, for example, the skills the user needs to obtain to perform a particular task. A user that is working in an organization or that is a consultant, contractor, or freelancer, may have trouble conveying succinctly the user's strengths to an employer.

Accordingly, systems and methods are desirable that normalize skills of a user for project management, educational assessment, personal assessment or other purposes. Discipline maps that represent normalized skills of users may also be desirable to allow a project manager or other individual to quickly and efficiently compare and contrast users.

### SUMMARY

Systems and methods are disclosed for creating a discipline map for a user and using the discipline map to assess the knowledge and experience of the user in a designer/developer context for a project. The discipline map may represent one or more attributes and an ability level the user possesses for one or more attributes. An attribute can be a set of skills associated with designer tasks and/or developer tasks of a project. A skill can be obtained through training and experience and a skill can predict whether the user can successfully complete the task. The ability levels may represent depth of a user's knowledge and experience. Discipline maps according to certain embodiments can be used to assess educational needs of one or more users, to allow a user to conduct a personal assessment of his or her strengths and weaknesses, and to plan a project, such as a software project, publishing project, or a motion picture project.

In one embodiment, a discipline map is provided. The discipline map has at least one region associated with an attribute of a project. The region(s) include a first section associated with a first threshold and a second section associated with a second threshold. The first threshold and the second threshold represent ability levels for the attribute. Data of a user is determined to meet or exceed the first threshold and/or the second threshold. The discipline map is modified by a discipline map engine stored on a computer-readable medium. The discipline map engine is executable by a processor to cause a computing device to modify the discipline map to indicate the data of the user meets or exceeds the first threshold and/or the second threshold. A user interface is provided. The user interface includes the discipline map modified by the discipline map engine. The discipline map modified by the discipline map engine represents the knowledge and experience of the user for the attribute.

In one embodiment, program components are provided that are tangibly embodied on a computer-readable medium accessible to a processor of a computer system. The program components include a discipline map engine and a workflow application. The discipline map engine can generate discipline maps. Each discipline map represents an ability level of a user for at least one attribute. The workflow application can plan a software program, output the discipline maps from the discipline map engine to a user interface, receive an identification of a task for a project, receive a selection of a discipline map from the discipline maps for the task, and associate the discipline map with the task.

In one embodiment, a first region associated with a first attribute of a discipline map is defined. A second region associated with a second attribute of the discipline map is defined. First sections in the first region are defined. Second sections in the second region are defined. The first sections and the second sections are associated with thresholds. Data of a user is compared to the thresholds to identify a threshold that the data of the user meets or exceeds. A section of the first sections or the second sections associated with the threshold that the data of the user meets or exceeds is coded. The discipline map having the section coded is outputted. The discipline map having the section coded represents the knowledge and experience of the user for a project.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings, where:

FIG. 1 is a block diagram of a system for creating a discipline map and using the discipline map in a designer/developer context for a project according to one embodiment;

FIG. 2 is an uncoded discipline map according to one embodiment;

FIG. 3 is a flow chart of a method for creating a discipline map for a user according to one embodiment;

FIG. 4A is a coded discipline map according to one embodiment;

FIG. 4B is a coded discipline map according to a second embodiment;

FIG. 5A is a flow chart of a method for using a discipline map to plan a software project according to one embodiment;

FIG. 5B is a flow chart of a method for using a discipline map to plan a software project according to a second embodiment;

FIG. 6 is a screen shot of a workflow application for planning a software project that includes tasks, each task using a discipline map according to one embodiment;

FIG. 7 is a screen shot of allowing tools to be associated with a task of the workflow application according to one embodiment.

### DETAILED DESCRIPTION

Certain embodiments are systems and methods for creating a persona that is a discipline map for a user and using the discipline map to assess the knowledge and experience of the user in a designer/developer context for a project. The discipline map may represent one or more attributes and an ability level the user possesses for one or more attributes. An attribute can be a set of skills associated with designer tasks and/or developer tasks of a project. A skill can be obtained through training and experience and a skill can predict whether the user can successfully complete the task. The ability levels may be a representing depth of a user's knowledge and experience. One ability level can represent that the user has a basic, working understanding of skills associated with an attribute and can perform tasks after receiving specific project instructions. A second ability level can represent that the user has a full, abstract understanding of skills associated with an attribute and can perform tasks with little instruction. A third ability level may be provided that represents that the user has an understanding of skills between a basic understanding and a full understanding of the skills, such as a mastery understanding of skills associated with an attribute.

Discipline maps according to various embodiments can be used for any type of project. Examples of projects in which discipline maps can be used include a software project, a publishing project, a motion picture project, or other creative project. Furthermore, although discipline maps are described with reference to a designer/developer context and for designers and developers, discipline maps according to certain embodiments can be applied in other disciplines, project types, and industries. For example, one or more discipline maps can be used in a resource allocation tool for allocating users or teams of users.

A discipline map that is a visual representation of the knowledge and experience of a user can be generated using data received from the user, or otherwise data obtained about the user. The discipline map can include attributes associated with designer tasks, such as the user interface design of a project, and can include attributes associated developer tasks of the project. Examples of attributes associated with designer tasks include layout design, interactive design, visual design, and motion and audio design. Examples of attributes associated with developer tasks include software architecture, scripting and programming, data operations and models, and content and structure. Each attribute can be associated with ability levels, such as three ability levels that represent varying degrees of experience with skills associated with the attribute.

A discipline map for a user can be generated from data of the user. In some embodiments, the discipline map is a shape such as a circle having regions defined within the circle to represent attributes. For example, one region can correspond to one attribute. Each region can have sections defined within the region to represent ability levels. Each attribute can be associated with specific skills for the attribute. The data of the user can be analyzed to determine whether the user possesses some baseline level of knowledge and experience represented by the specified skills for the attribute. If the user possesses a baseline level of knowledge and experience, the ability level associated with the attribute for the user can be determined. The section associated with the ability level determined for the user, as well as the section(s) for ability levels that are less than the determined ability level, for the attribute can be coded. An example of coding sections includes darkening the sections or filling the sections with color. The process can be repeated for each of the attributes. The discipline map for a user can include certain sections of certain regions coded and the remaining sections of the certain regions or other regions uncoded.

Discipline maps according to certain embodiments can be used by a project manager to determine quickly and efficiently a user to perform project tasks. In some embodiments, a system can suggest a user to perform tasks by analyzing discipline maps for users that are available to perform the tasks and the skills necessary to complete the tasks successfully. A discipline map for a user can be used also by the user to identify attributes for which the user needs additional experience to perform tasks that the user desires to perform. In other embodiments, discipline maps can be used to formulate training or education seminars on topics that the discipline maps indicate may be of interest to users.

Although various embodiments are described herein for developing a discipline map for a user, a discipline map can be developed for all users of a team of users. For example, a discipline map for all users of a team of users can represent the collective knowledge and experience of the team of users.

These illustrative examples are given to introduce the reader to the general subject matter discussed here and are not intended to limit the scope of the disclosed concepts. The following sections describe various additional embodiments and examples with reference to the drawings in which like numerals indicate like elements.

### Illustrative System Implementation

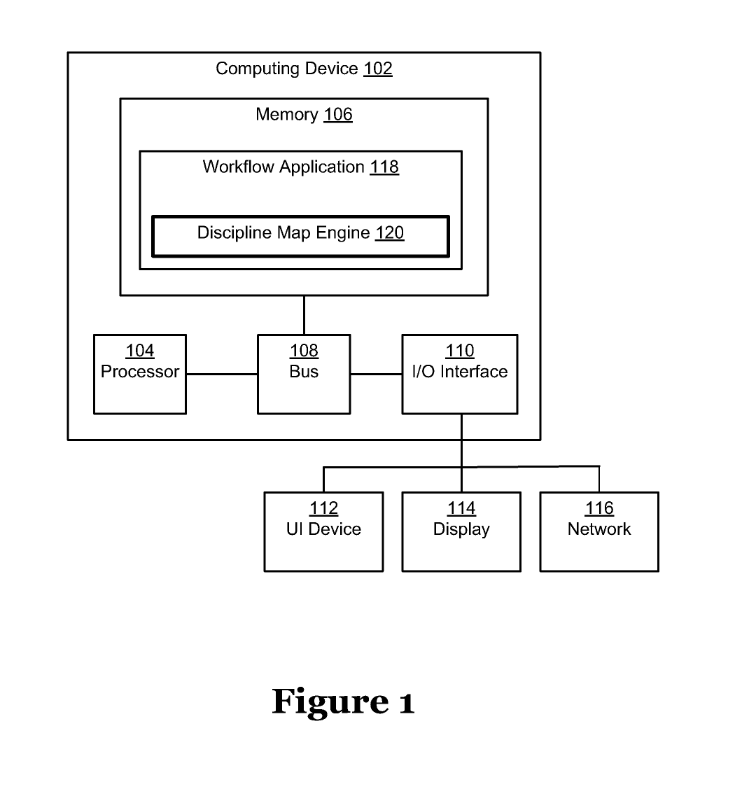

FIG. 1 depicts a system that is capable of creating a discipline map for a user and using the discipline map to assess the knowledge and experience of the user in a designer/developer context for a project according to certain embodiments. Other embodiments may be utilized. The system includes a computing device 102 having a processor 104 that can execute code stored on a computer-readable medium, such as a memory 106, to cause the computing device 102 to create discipline maps and to allow the discipline maps to be used in, for example, project planning, educational assessment, and personal assessment. The computing device 102 may be any device that can process data and execute code that is a set of instructions to perform actions. Examples of the computing device 102 include a desktop personal computer, a laptop personal computer, a server device, a handheld computing device, and a mobile device.

Examples of the processor 104 include a microprocessor, an application-specific integrated circuit (ASIC), a state machine, or other suitable processor. The processor 104 may include one processor or any number of processors. The processor 104 can access code stored in the memory 106 via a bus 108. The memory 106 may be any tangible computer-readable medium capable of storing code. The memory 106 can include electronic, magnetic, or optical devices, capable of providing processor 104 with executable code. Examples of the memory 106 include random access memory (RAM), read-only memory (ROM), a floppy disk, compact disc, digital video device, magnetic disk, an ASIC, a configured processor, or other storage device capable of tangibly embodying code. The bus 108 may be any device capable of transferring data between components of the computing device 102. The bus 108 can include one device or multiple devices.

The computing device 102 can share data with additional components through an input/output (I/O) interface 110. The I/O interface 110 can include a USB port, an Ethernet port, a serial bus interface, a parallel bus interface, a wireless connection interface, or any suitable interface capable of allowing data transfers between the computing device and another component. The additional components can include a user input (UI) device 112, a display 114, and a network 116. The UI device 112 can include a keyboard, a mouse device, a touch screen interface, or other device capable of receiving commands from a user and providing the commands to the computing device 102. The display 114 can include a liquid crystal display (LCD), a plasma screen, cathode ray tube (CRT), or any device capable of displaying images generated by the computing device 102. The network 116 can include the internet, an intranet, wide area network (WAN), local area network (LAN), virtual private network (VPN), or any suitable communications network that allows computing device 102 to communicate with other components.

Instructions can be stored in the memory 106 as executable code. The instructions can include processor-specific instructions generated by a compiler and/or an interpreter from code written in any suitable computer-programming language, such as C, C++, C#, Visual Basic, Java, Python, Pert, JavaScript, and ActionScript. The instructions can include a workflow application 118 that, when executed by the processor 104, can cause the computing device 102 to provide a user interface and other information with which a project can be planned. The workflow application 118 includes a discipline map engine 120 that, when executed with the workflow application 118 by the processor 104 can cause the computing device 102 to create one or more discipline maps and allow the discipline maps to be used in the workflow application 118, for example. In other embodiments, a computing device is provided that includes the discipline map engine 120 in an application other than workflow application 118, or as an independent application.

This exemplary system configuration is provided merely to illustrate a potential configuration that can be used to implement certain embodiments. Other configurations may of course be utilized.

### Exemplary Discipline Map and Generation Method

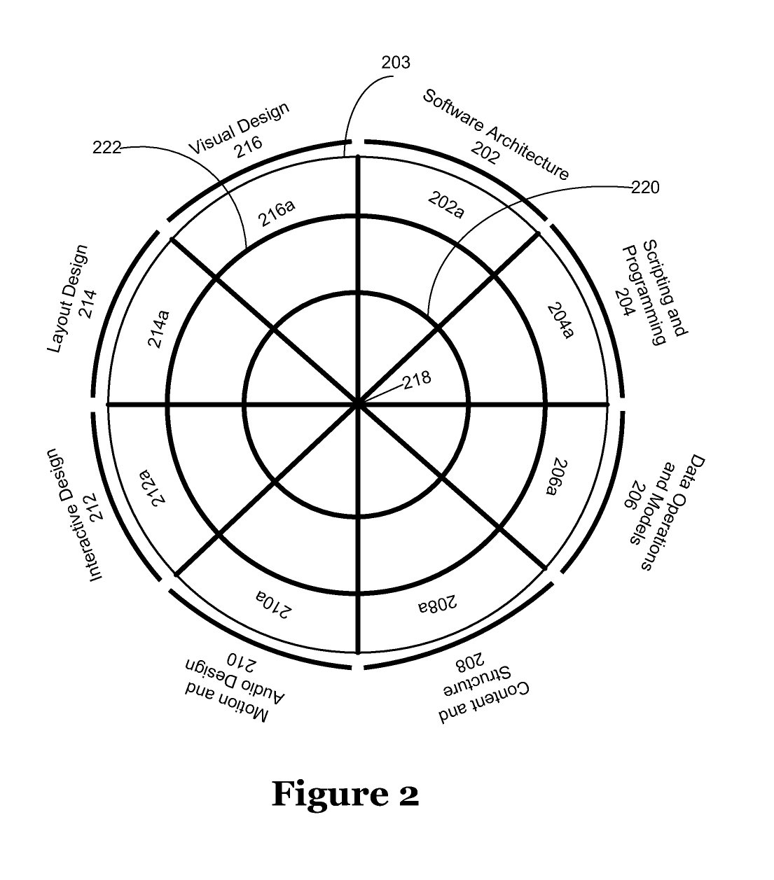

FIG. 2 depicts an uncoded discipline map according to one embodiment. The discipline map is represented by a circle 203, with developer attributes on one portion of the circle 203 and designer attributes on a second portion of the circle 203. Although the discipline map is represented by the circle 203 in FIG. 2, any shape may be used to represent the discipline map. Furthermore, the discipline map in FIG. 2 includes specific designer and developer attributes associated with software project that may be particularly relevant. However, various embodiments of the discipline map can include other attributes and any number of attributes related to a software project or other type of project.

The developer attributes include software architecture 202, scripting and programming 204, data operations and models 206, and content and structure 208. Software architecture 202 relates to using, creating, and planning reusable frameworks, components, and application programming interfaces (APIs) for a software project. Scripting and programming 204 relates to writing code to create data interactivity for a software project. Data operations and models 206 relates to interacting with data sets or data servers to support web applications and interactive experiences for a software project. Content and structure 208 relates to organizing and structuring content with various levels of abstraction, including defining abstraction between content, style, or user interface components and object classes for a software project.

The designer attributes include motion and audio design 210, interactive design 212, layout design 214, and visual design 216. Motion and audio design 210 relates to using motion, video, and audio to convey concepts or relationships to add value to web and interactive experiences on a user interface for the software project. Interactive design 212 relates to creating and understanding user interaction and interface experiences to develop consistent models and expand interaction experiences on a user interface for a software project. Layout design 214 relates to creating a navigable method for a user to receive content using one or more media types and methods, such as text flow, unique positioning, and value attribution based on context, to provide a level of interaction beyond language on a user interface for a software project. Visual design 216 relates to using style, artistic expression, and non-literal interpretation to create and extend visual representations on a user interface for a project.

Regions 202a-216a are defined in the circle 203. Each region is associated with one attribute. For example, region 202a is associated with software architecture 202, region 204a is associated with scripting and programming 204, etc. The regions 202a-216a may be defined by lines intersecting at a center 218 of the circle 203. Each region includes sections defined in the region. The sections can represent ability levels for the attribute. Each region in FIG. 2 includes three sections. Two inner circles can, along with lines intersecting at the center 218, define the sections. For example, a first inner circle 220 and two of the lines intersecting the center 218 can define a first section in each region. A second section in each region can be defined between the first inner circle 220 and a second inner circle 222 and between two of the lines intersecting at the center 218. A third section in each region can be defined between the second inner circle 222 and the circle 203 and between two of the lines intersecting at the center 218. The first section can represent a low understanding of an attribute. The second section can represent a medium understanding of an attribute. The third section can represent a high understanding of an attribute. Although the discipline map depicted in FIG. 2 includes three sections representing varying ability levels, discipline maps according to various embodiments can include any number of sections.

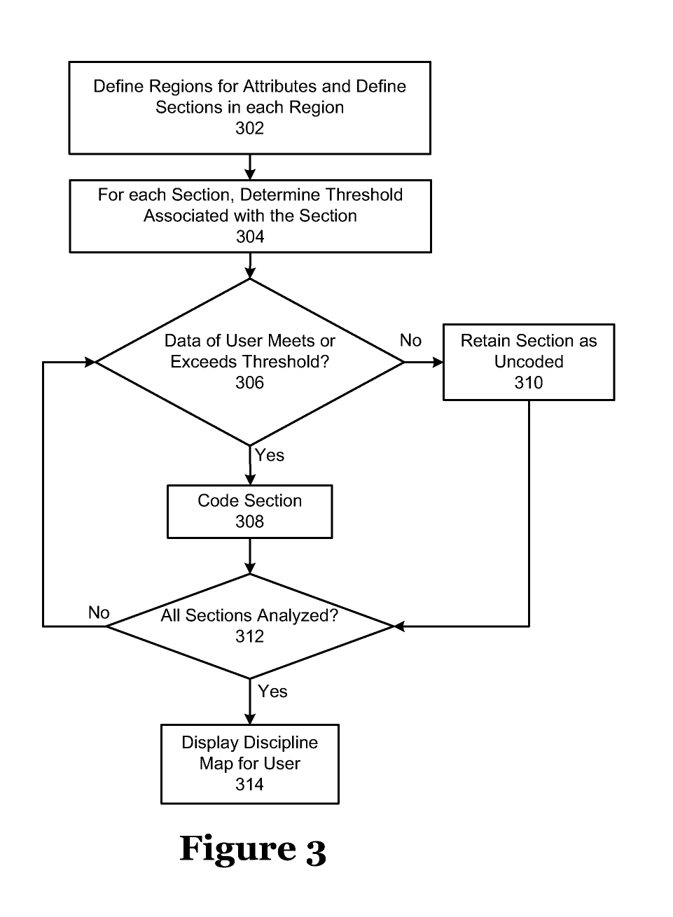

The discipline map can be coded using data of a user. FIG. 3 depicts a method for generating a discipline map for a user that is coded according to one embodiment. The method shown in FIG. 3 is described with reference to the system depicted in FIG. 1 and the uncoded discipline map depicted in FIG. 2. However, the method shown in FIG. 3 can be implemented using other systems and other discipline map embodiments.

In block 302, the discipline map engine 120 defines regions for attributes and defines sections for each region. The discipline map engine 120 can receive an identification of attributes from an administrator or the discipline map engine 120 can be configured to provide attributes automatically. The discipline map engine 120 can create a region for each of the attributes by configuring lines intersecting at the center 218 of the circle 203. The discipline map engine 120 can be configured with a pre-set number of sections to define in each region. The discipline map engine 120 can create the sections for each region by configuring the first inner circle 220 and the second inner circle 222.

In block 304, the discipline map engine 120 determines, for each section, a threshold associated with the section. The threshold for a section may be the minimum knowledge and experience that a user must possess to be eligible to have the section coded for the user. The threshold can be represented by one or more skills that specify the knowledge and experience for a section of a particular attribute. For example, the first section of region 202a can be associated with a threshold related to basic skills of software architecture 202. In some embodiments, the thresholds for the sections are configured by an administrator and can be changed, depending on the type of projects to which the discipline maps are applied. In other embodiments, the thresholds for the sections are not configurable by an administrator.

In block 306, the discipline map engine 120 compares the data of a user to a threshold of a section to determine whether the data of the user meets or exceeds the threshold. Examples of data of the user that can be compared include a representation of a user's understanding of technologies, paradigms, concepts, and contexts of an attribute associated with the section, an amount of time working with in the same or similar area as the attribute, education obtained that is relevant to the attribute, and other similar data.

If the data of the user meets or exceeds the threshold, the discipline map engine 120 codes the section in block 308. The section can be coded by the discipline map engine 120 filling the section with a color such as black. If the data of the user fails to meet or exceed the threshold, the discipline map engine 120 retains the section as uncoded in block 310. The section may be retained as uncoded by retaining its initial fill color.

In block 312, the discipline map engine 120 determines whether all sections, or at least relevant sections, of the discipline map have been analyzed. In some embodiments, the discipline map engine 120 can analyze one section of a region associated with an attribute and determine that an analysis of the other sections of the region is not needed. For example, the discipline map engine 120 may analyze the first section of region 202a and determine that the data of the user fails to meet or exceed the threshold associated with the first section of region 202a. The discipline map engine 120 can determine that the other sections of region 202a—the second section and the third section—do not need to be analyzed because the data of the user failed to meet or exceed the threshold for the first section.

If the discipline map engine 120 determines that all sections, or at least all relevant sections, have not been analyzed, the process returns to block 306 and the discipline map engine 120 compares the data of a user to a threshold for a section not yet analyzed. If the discipline map engine 120 determines that all sections, or all relevant sections, have been analyzed, the discipline map engine 120 displays the discipline map for the user in block 314. For example, the discipline map engine 120 can provide a user interface on which the discipline map is displayed and provide the user interface with the discipline map to the display 114.

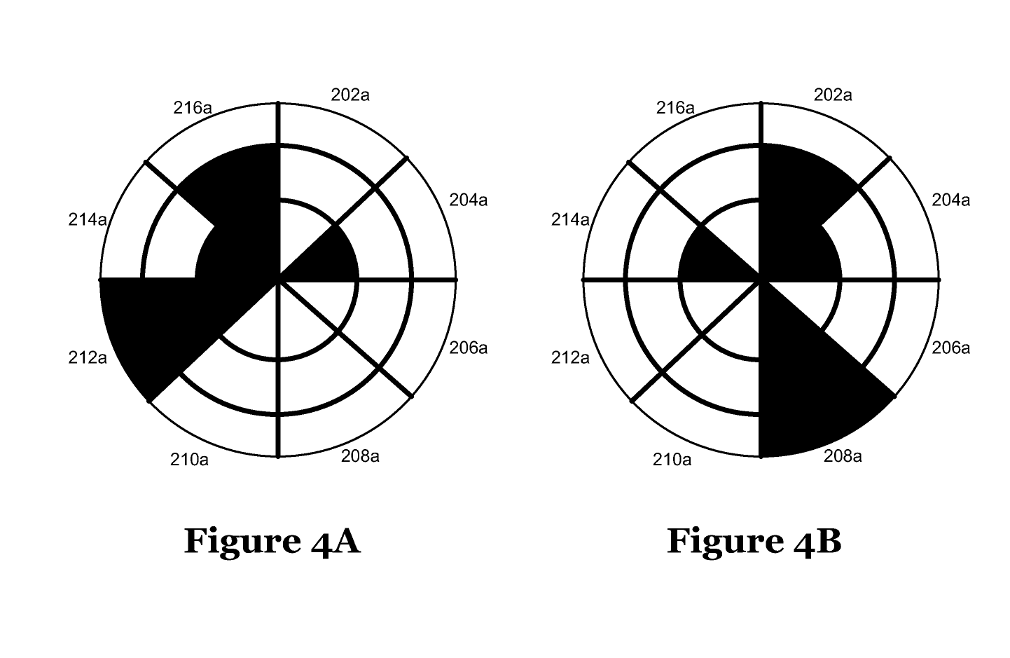

FIGS. 4A and 4B depict examples of coded discipline maps according to certain embodiments. The discipline map depicted in FIG. 4A shows that a user has met or exceeded thresholds for (i) a first section in region 204a, (ii) a first section, a second section, and a third section in region 212a, (iii) a first section in region 214a, and (iv) a first section and a second section in region 216a. The discipline map depicted in FIG. 4B shows that a user has met or exceeded thresholds for (i) a first section and a second section in region 202a, (ii) a first section in region 204a, (iii) a first section, a second section, and a third section in region 208a, and (iv) a first section in region 214a.

Discipline maps according to certain embodiments can be used in a variety of implementations. In some embodiments, a user can review a discipline map for the user to identify the attributes for which the user needs to gain additional knowledge and experience. For example, a user associated with the discipline map depicted in FIG. 4A can review it to identify the layout design 214 attribute, associated with region 214a, as an area for which the user needs to gain additional knowledge and experience. In some embodiments, an educational curriculum developer can review discipline maps of various users to identify areas for which education may be desired or needed and use it to formulate an educational curriculum that may interest the users. In other embodiments, discipline maps can be used to plan a project such as software project by, for example, assigning tasks of a software project to users based on discipline maps.

### Exemplary Methods of Using Discipline Maps to Plan Software Projects

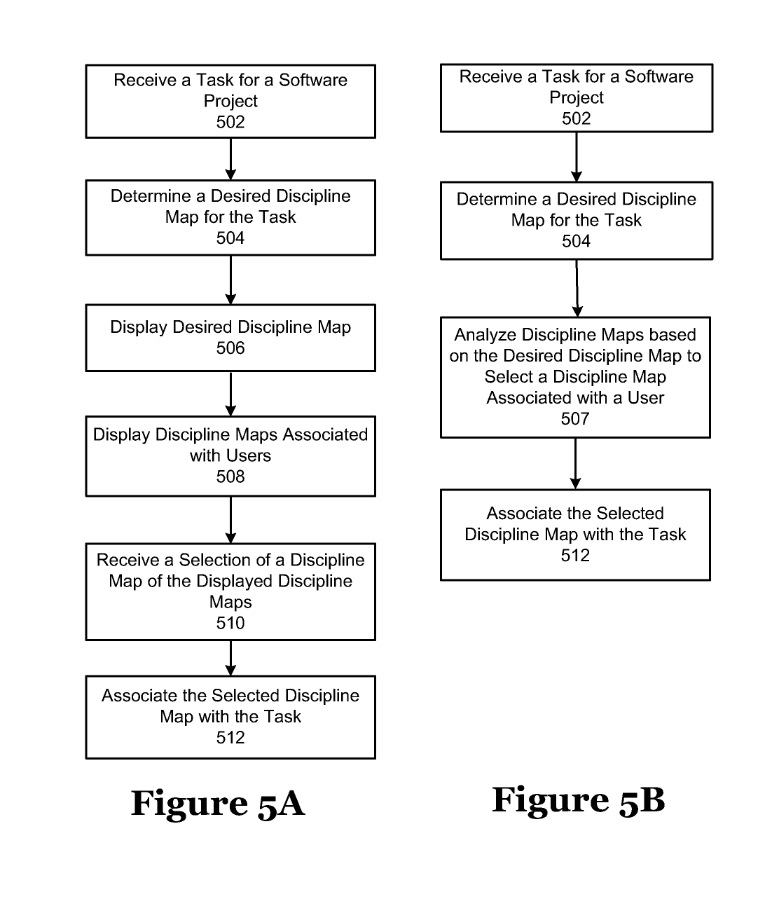

FIG. 5A depicts a method for using discipline maps to plan software projects in the workflow application 118 according to one embodiment. Although FIG. 5A is described with reference to the system of FIG. 1, other system implementations are possible. Although, FIG. 5A is described as applying to a software project, the process can be applied to any type of project.

In block 502, the workflow application 118 receives at least one task for a software project. The at least one task may be a designer task or a developer task that needs to be completed for the software project. For example, a project manager can plan a software project by identifying tasks to be performed to complete the software project. The workflow application 118 can receive an identification of the at least one task from a project manger command through the UI device 112 and I/O interface 110.

In block 504, the discipline map engine 120 determines a desired discipline map for the task. In some embodiments, the discipline map engine 120 accesses historical data stored in memory 106 or a data storage device external to computing device 102. The historical data can include instances of successful completions of tasks that are the same as or similar to the at least one task received for the software project and discipline maps of users that successfully completed the same or similar tasks. The discipline map engine 120 can determine a desired discipline map that is coded similar to, or the same as, the stored discipline maps of users that successfully completed the same or similar tasks. In other embodiments, the discipline map engine 120 is configured with a coded discipline map associated with the at least one task received for the software project that is the desired discipline map.

In block 506, the discipline map engine 120 displays the desired discipline map for the at least one task. For example, the discipline map engine 120 can provide a user interface that includes the desired discipline map and can output the user interface with the desired discipline map to the display 114.

In block 508, the discipline map engine 120 can display discipline maps associated with users that are available and willing to perform tasks associated with the software project. The discipline maps associated with the users can be displayed on a user interface provided by the discipline map engine 120.

In block 510, the discipline map engine 120 receives a selection of a discipline map from the displayed discipline maps. The selection can be a command received through the UI device 112 and the I/O interface 110. The selection may represent the project manager's identification of a user to perform the received task that is based on a review of the desired discipline map and the displayed discipline maps. For example, the project manager can identify a discipline map from the displayed discipline maps, where the identified discipline map is coded similarly, or the same as, the desired discipline map.

In block 512, the discipline map engine 120 associates the selected discipline map with the task. In some embodiments, the discipline map engine 120 stores the selected discipline map associated with the task in memory 106. Associating with selected discipline map with the task may correspond with assigning the user associated with the selected discipline map to the task. The discipline map engine 120 may generate and transmit a notification to the user associated with the selected discipline map to notify the user of the assignment.

In some embodiments, the selection of a discipline map from the discipline maps of the users available to perform tasks can be performed by the discipline map engine 120. FIG. 5B depicts an embodiment of a method for selecting a discipline map for use in planning a software project. The method includes blocks 502 and 504 as described with reference to FIG. 5A.

In block 507, the discipline map engine 120 analyzes the available discipline maps using the desired discipline map to select a discipline map. For example, the discipline map engine 120 may determine the coded sections of the desired discipline map and identify discipline maps from the available discipline maps with the same or similar sections coded. The discipline map engine 120 can select a discipline map that has sections coded most similar, among the available discipline maps, to the desired discipline map. The discipline map engine 120 can associate the selected discipline map with the task as in block 512. In some embodiments, the discipline map engine 120 outputs the selected discipline map for review by a project manager or otherwise.

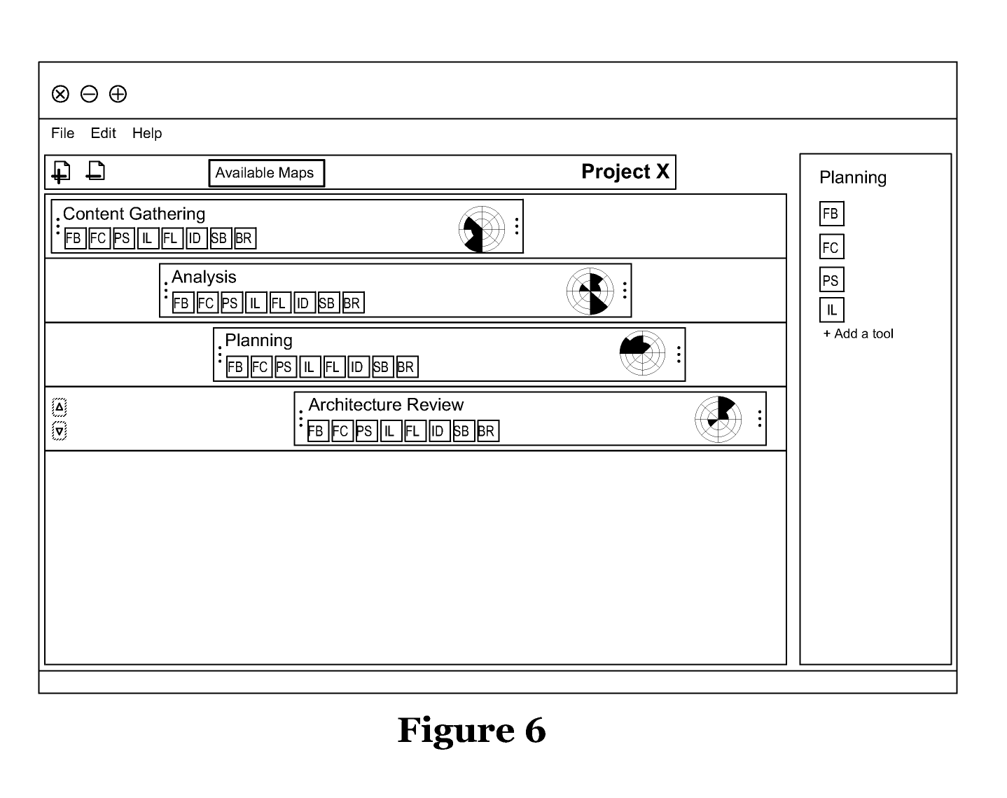

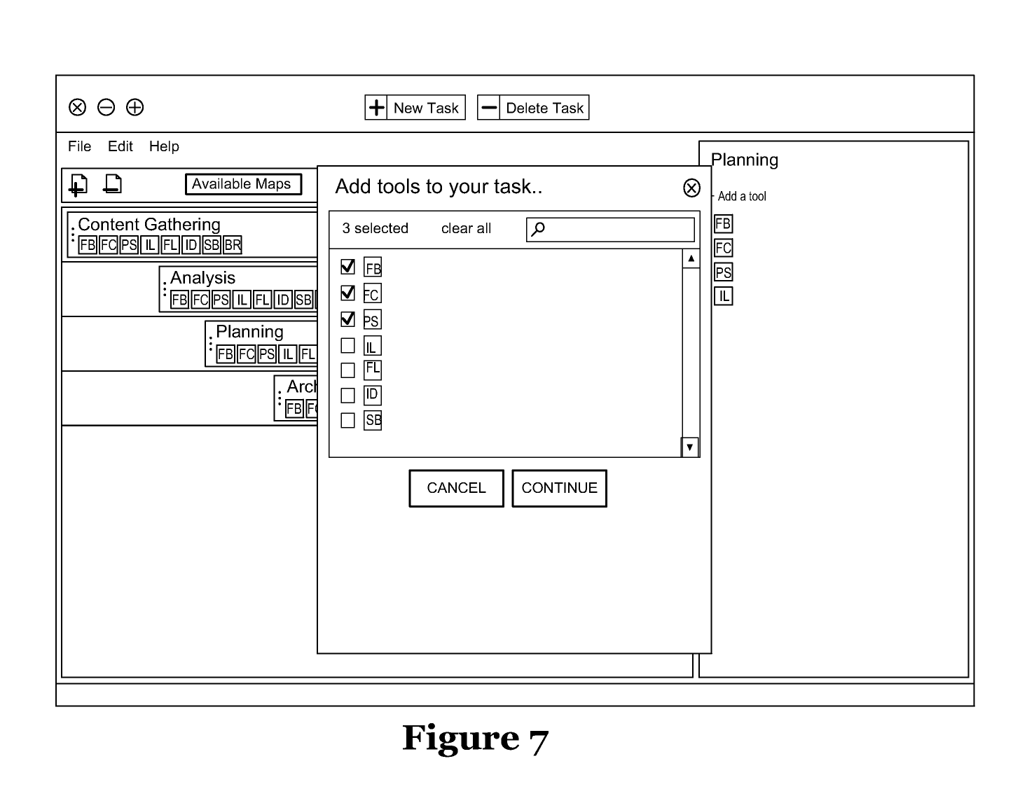

FIGS. 6 and 7 depict screen shots of a user interface provided by the workflow application 118 and using discipline maps provided by the discipline map engine 120. FIG. 6 shows a project plan for “project X”. The project plan includes four tasks: content gathering, analysis, planning, and architecture review. For example, the workflow application 118 can receive a command from a project manager to add one or more tasks to the project plan. The workflow application 118 can also receive, for each task, an identification of one or more software tools that may be used by a user to complete the task. Identifications of software tools are represented in FIG. 6 by blocks labeled “FB,” “FC,” “PS,” “FL,” etc. Software tools may be software applications that can be used to perform the task. FIG. 7 depicts a user interface through which the workflow application 118 can receive a command from a project manager selecting one or more software tools from a list of software tools for the task of “Planning.” The workflow application 118 can associate the selected software tools with the task.

In some embodiments, the software tools can be used by the discipline map engine 120 to determine skills associated with a task. The skills can be used by the discipline map engine 120 to determine a desired discipline map for the task. In FIG. 6, the user interface provided by the workflow application 118 includes a desired discipline map associated with each task. A selectable button labeled “Available Maps” is provided on the user interface. The discipline map engine 120 can receive a command that is a request for available discipline maps and can provide a user interface that includes available discipline maps from which a project manager can select based on, for example, the desired discipline map. In some embodiments, the discipline map engine 120 compares the desired discipline map to the available discipline maps to identify a discipline map from the available discipline maps to at least suggest to the project manager. The discipline map engine 120 can provide a user interface that includes the suggested discipline map and cause the user interface to be displayed to the project manager.

In other embodiments, discipline maps can be used by a user to determine a tool from a group of tools to use. Examples of tools include tools for performing designer tasks and tools for performing developer tasks. Each tool from the group of tools may be associated with one or more sections of a discipline map. For example, a tool can be associated with one section of one region, with two sections of one region, or with one section of a first region and another section of a second region. The associations can be based on successful uses of tools to complete tasks associated with a particular attribute and/or the associations can be received from an administrator. For example, a particular tool may be associated with a section of the visual design attribute 216 because the particular tool is useful for performing tasks associated with the visual design attribute 216. The associations can be stored in memory 106.

The discipline map engine 106 can create a discipline map for a user based on data of the user. An application, such as workflow application 118 or otherwise, can use the discipline map for the user to identify one or more tools from the group of tools to suggest to the user. The suggested tools can be selected based on the discipline map of the user. For example, if a discipline map for a user includes two sections of the visual design attribute 216 coded, the application can identify certain tools associated with one or both of the two sections of the visual design attribute 216 to be suggested to the user. The suggested tools may be useful in performing certain tasks associated with visual design. A list of the certain tools can be displayed on a user interface that is provided to the user. In some embodiments, the list includes selectable links that, when selected by a user, provide the user with access to the selected tool.

### General

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A computer-implemented method comprising:
providing a discipline map having at least one region associated with an attribute of a project, the attribute being a set of skills associated with a plurality of tasks for the project, wherein the at least one region comprises a first section associated with a first threshold and a second section associated with a second threshold, the first threshold representing a first ability level of a user to successfully complete the plurality of tasks for the project and the second threshold representing a second ability level of the user to successfully complete the plurality of tasks for the project, the second ability level being more advanced than the first ability level;
determining data of the user at least meets at least one of the first threshold or the second threshold;
modifying the discipline map by a discipline map engine executed by a processor device to indicate the data of the user at least meets at least one of the first threshold or the second threshold; and
providing a user interface having the discipline map modified by the discipline map engine, the discipline map modified by the discipline map engine representing a knowledge and an experience of the user for the attribute and predicting that the user can successfully complete at least one of the plurality of tasks.

2. The method of claim 1, wherein the first threshold represents a low ability level and the second threshold represents a high ability level.

3. The method of claim 2, wherein determining data of a user at least meets at least one of the first threshold or the second threshold comprises:
comparing the data of the user to the first threshold to determine the data of the user at least meets the first threshold;
comparing the data of the user to the second threshold to determine the data of the user fails to at least meet the second threshold,
wherein modifying the discipline map to indicate the data of the user at least meets at least one of the first threshold or the second threshold comprises:
coding the first section associated with the first threshold to represent that the data of the user at least meets the first threshold;
retaining the second section associated with the second threshold as uncoded to represent that the data of the user fails to at least meet the second threshold.

4. The method of claim 3, wherein coding the first section associated with the first threshold to represent that the data of the user at least meets the first threshold comprises darkening the first section,
wherein retaining the second section associated with the second threshold as uncoded to represent that the data of the user fails to at least meet the second threshold comprises retaining an initial fill color for the second section.

5. The method of claim 1, wherein the discipline map is a circle having the at least one region defined by lines intersecting a center of the circle,
wherein the first section and the second section are defined by an inner circle disposed inside the circle.

6. The method of claim 5, wherein the circle comprises a plurality of regions, each region of the plurality of regions being associated with one of a plurality of attributes associated with the project and each region of the plurality of regions having the first section, the second section, and a third section representing a medium ability level, the third section being defined by a second inner circle disposed inside the circle.

7. The method of claim 1, further comprising:
receiving an identification of a task for the project;
receiving a selection of the discipline map modified by the discipline map engine; and
assigning the task to the user by associating the task with the discipline map modified by the discipline map engine.

8. The method of claim 7, wherein receiving the selection of the discipline map modified by the discipline map engine comprises:
analyzing, by a workflow application executed by the processor device, the discipline map modified by the discipline map engine and a desired discipline map for the task; and
selecting, by the workflow application, the discipline map modified by the discipline map engine based on the analysis.

9. The method of claim 1, further comprising:
determining at least one tool from a plurality of tools to identify to the user based on the discipline map modified by the discipline map engine; and
providing the user interface comprising an identification of the at least one tool.

10. The method of claim 9, wherein determining the at least one tool from the plurality of tools to identify to the user based on the discipline map modified by the discipline map engine comprises:
determining the at least one tool is associated with the first section;
determining the discipline map modified by the discipline map engine comprises a first section that is coded; and
selecting the at least one tool from the plurality of tools based on the at least one tool being associated with the first section and based on the first section of the discipline map modified by the discipline map engine being coded.

11. A computer system comprising a processor with access to a computer-readable medium tangibly embodying program components, the program components comprising:
a discipline map engine capable of generating a plurality of discipline maps, each discipline map of the plurality of discipline maps representing an ability level of a user for at least one attribute; and
a workflow application capable of planning a project, the workflow application being further capable of:
outputting the plurality of discipline maps from the discipline map engine to a user interface;
receiving an identification of a task for the project;
receiving a selection of a discipline map from the plurality of discipline maps for the task, the discipline map being for the user; and
associating the discipline map for the user with the task.

12. The computer system of claim 11, wherein the workflow application is further capable of:
determining a desired discipline map associated with the task; and
outputting the desired discipline map to the user interface.

13. The computer system of claim 11, wherein the workflow application is further capable of:
determining a desired discipline map for the task based on at least one software tool associated with the task;
analyzing the plurality of discipline maps and the desired discipline map for the task; and
selecting at least one discipline map from the plurality of discipline maps that has at least one coded section that is a coded section on the desired discipline map.

14. The computer system of claim 11, wherein each discipline map of the plurality of discipline maps is a circle having a plurality of regions defined by lines intersecting a center of the circle, each region of the plurality of regions being associated with an attribute of a plurality of attributes and each region of the plurality of regions having a plurality of sections representing ability levels for the attribute.

15. The computer system of claim 14, wherein the plurality of sections are defined by inner circles disposed inside the circle.

16. The computer system of claim 11, wherein the workflow application is capable of:
assigning the task to the user by associating the discipline map for the user with the task; and
outputting a notification of assignment to the task to the user.

17. A computer-readable storage medium on which is encoded program code, the program code comprising:
program code for defining a discipline map having a first region associated with a first attribute of a project and a second region associated with a second attribute of the project, the first attribute being a first set of skills associated with a first plurality of tasks for the project, the second attribute being a second set of skills associated with the project;
program code for defining a first plurality of sections in the first region and a second plurality of sections in the second region, wherein the first plurality of sections and the second plurality of sections are each associated with respective thresholds representing ability levels predicting that a user can successfully complete tasks of the first plurality of tasks for the project and of the second plurality of tasks for the project;
program code for comparing data of a user to the thresholds to identify a threshold that the data of the user at least meets;
program code for coding a section of the first plurality of sections or the second plurality of sections associated with the threshold that the data of the user at least meets; and
program code for outputting the discipline map having the section coded, the discipline map having the section coded representing a knowledge and an experience of the user for a project and predicting that the user can successfully complete at least one task of the first plurality of tasks or the second plurality of tasks.

18. The computer-readable storage medium of claim 17, wherein the thresholds comprise a first threshold representing a low ability level for an attribute, a second threshold representing a medium ability level for the attribute, and a third threshold representing a high ability level for the attribute.

19. The computer-readable storage medium of claim 17, wherein the discipline map having the section coded comprises a circle comprising:
the first region and the second region defined by lines intersecting a center of the circle; and
the first plurality of sections and the second plurality of sections being defined by a first inner circle and a second inner circle disposed in the circle

20. The computer-readable storage medium of claim 17, further comprising:
program code for receiving an identification of a task for the project;
program code receiving a selection of the discipline map having the section coded; and
program code for assigning the task to the user by associating the task with the discipline map having the section coded.

21. The computer-readable storage medium of claim 20, wherein program code for receiving the selection of the discipline map having the section coded comprises
program code for analyzing the discipline map having the section coded and a desired discipline map for the task; and
program code for selecting the discipline map having the section coded, based on the analysis.

22. The computer-readable storage medium of claim 17, wherein program code for coding the section of the first plurality of sections or the second plurality of sections associated with the threshold that the data of the user at least meets comprises:
program code for darkening the section associated with the threshold that the data of the user at least meets, wherein the user is a team comprised of a plurality of users.
